(19) United States
(12) Patent Application Publication
(10) Pub. No.: US 2023/0178056 A1
(43) Pub. Date: Jun. 8, 2023

(54) Handheld musical instrument with control buttons

(71) Applicant: Arne Schulze, Reno, NV (US)

(72) Inventor: Arne Schulze, Reno, NV (US)

(21) Appl. No.: 18/075,295

(22) Filed: Dec. 5, 2022

Related U.S. Application Data
(63) Continuation-in-part of application No. 18/075,074, filed on Dec. 5, 2022.
Application No. 18/075,074 is a continuation-in-part of application No. 18/074,421, filed on Dec. 2, 2022.
(60) Provisional application No. 63/286,105, filed on Dec. 6, 2021.

(51) Int. Cl. G10H 1/00; G10H 1/46; G10H 1/34

(52) U.S. Cl. CPC G10H 1/0008; G10H 1/46; G10H 1/0066; G10H 1/34; G10H 2220/101; G10H 2220/271; G10H 2210/381; G10H 2250/435; G10H 2220/061; G10H 2240/311

(57) ABSTRACT

A handheld musical instrument for playing a variety of audio program, the handheld musical instrument comprising a body portion with one or more sensors and a handle portion coupled to said body part, wherein said handle portion includes one or more operational buttons to control the operation of said handheld musical instrument. The buttons being operated with a finger or thumb trigger.

### CROSS-REFERENCE TO RELATED APPLICATIONS

The present Continuation-in-part patent application claims priority benefit under 37 CFR 1.53(b) of the continuation-in-part patent application Ser. No. 18/075,074, entitled “A handheld musical instrument with gesture control”, filed on 2022 Dec. 5, and further claims priority of 35 U.S.C 120 of the nonprovisional patent application Ser. No. 18/074,421 entitled “A Handheld musical Instrument” filed on 2022 Dec. 2, which further claims priority of U.S. provisional application for patent serial number #63/286,105, titled, “Handheld Electronic Percussion Instrument”, filed on 2021 Dec. 6 under 35 U.S.C. 119(e). The contents of these related patent application(s) are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to handheld electronic percussion instruments. More particularly, certain embodiments of the invention relates to various operating modes of the handheld electronic percussion instrument.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Electronic percussion instruments mimic traditional acoustic drum kits with electronic triggers corresponding to the various drums and cymbals of an acoustic kit. Striking a pad triggers a drum machine to play a percussion sound or sounds assigned to the pad or pads. Electronic percussion instruments may include a few preprogrammed audio settings to be played.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that selecting between user triggers and preprogrammed audio settings requires proper coordination.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a front perspective view of a handheld electronic musical instrument, in accordance with an embodiment of the present invention;

FIG. 2 illustrates a back perspective view of a handheld electronic musical instrument, in accordance with an embodiment of the present invention;

FIG. 3 illustrates a perspective view of a layout of control buttons on a handheld electronic musical instrument, in accordance with an embodiment of the present invention;

FIG. 4A illustrates a top perspective view of a layout of sensor pads and control buttons on a handheld electronic musical instrument, in accordance with an embodiment of the present invention;

FIG. 4B illustrates a front perspective view of a layout of sensor pads and control buttons on a handheld electronic musical instrument, in accordance with an embodiment of the present invention;

FIG. 4C illustrates a bottom perspective view of a layout of sensor pads and control buttons on a handheld electronic musical instrument, in accordance with an embodiment of the present invention;

FIG. 5A illustrates an elevation view of a handle of a handheld electronic musical instrument, in accordance with an embodiment of the present invention;

FIG. 5B illustrates a back elevation view of a handheld electronic musical instrument, in accordance with an embodiment of the present invention; and

FIG. 5C illustrates a perspective view of a handheld electronic musical instrument, in accordance with an embodiment of the present invention. Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C . . . sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s). Furthermore, any statement(s), identification(s), or reference(s) to a structure(s) and/or element(s) that corresponds to and/or supports a claim limitation(s) phrased in functional limitation terms covered by 35 USC § 112(6) (post AIA 112(f)) should be understood to be identified by way of example and not limitation, and as such, should not be interpreted to mean that such recited structure and/or element is/are the only structure(s) and/or element(s) disclosed in this patent application that corresponds to and/or supports such claim limitations phrased in functional limitation terms. This claims interpretation intention also applies to any such subsequent statements made by Applicant during prosecution.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Embodiments of the present invention disclose a handheld electronic musical instrument. The handheld electronic musical instrument comprises a body portion or part and a handle portion or a handlebar part. The handle part may be attached to the body part, detachably attached to the body part, or swivel able about the body part. The different ways in of attaching the body part with the handle part is discussed in detail in the parent application # . . . incorporated completely herein by reference. One side of the body part comprises a set of pads, for example, without limitations, rubber pads. The rubber pads are attached to pressure sensitive sensor, such as without limitations, a piezoelectric sensor. When a user of the handheld musical instruments strikes the rubber pads by finger or by hand the piezoelectric sensor is triggered and generates sound files for example, without limitations, digital drum sound files. The handle part of the handheld electronic percussion instrument comprises buttons enabling the user to select different program styles, such as, without limitation, a drum and percussion style program, a Musical Instrument Digital Interface (MIDI) percussion or musical sequences. The buttons may be operated with a finger or thumb trigger. The handle of the handheld electronic musical instrument also includes a sensor pad for generating special drum sound effects. The handle part includes different control buttons to control various operations of the handheld electronic musical instrument. The different control buttons include, for example, without limitations, a volume control button, LED power on/off light indicator, a preset rotary switch, finger velocity sensor buttons, multiple function buttons, etc. The output of the selected program style or sound generated by sensor triggers from the body part and the handle part are wired to an internal sound module. The sounds may be amplified and broadcast through loudspeakers controllers connected to the internal sound module. The loudspeakers controller may be wired or wirelessly connected to the internal sound module.

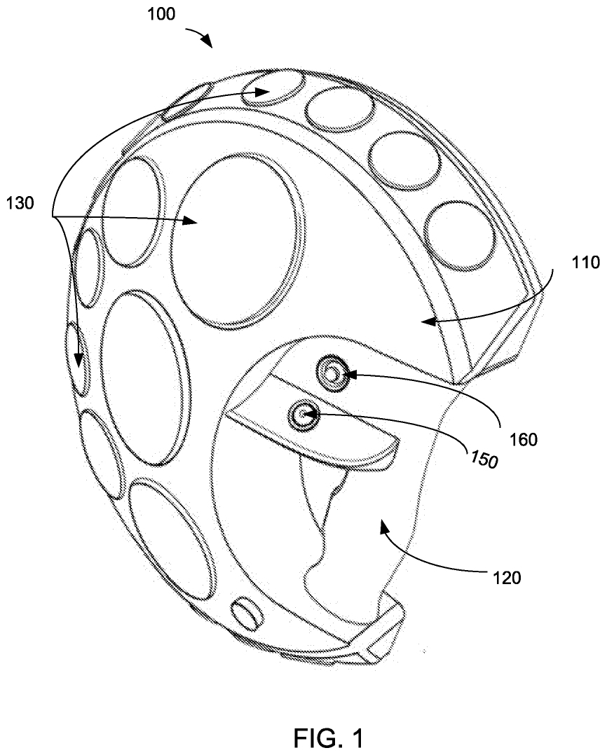

FIG. 1 illustrates a front perspective view of a handheld electronic musical instrument, in accordance with an embodiment of the present invention. In FIG. 1 an arrangement of sensor pads 130 and control buttons 150, 160 on instrument 100 is shown. Instrument 100 includes a body part 110 and a handle part 120, wherein sensor pads 130 are arranged on the body part 110. Sensor pads 130 include a pressure sensitive sensor pads such as, without limitations, piezoelectric sensor pads. Piezoelectric sensor pads get triggered when a user of instrument 100 taps on sensor pad 130 with a hand or a finger and produce percussion sounds, such as, without limitation, sounds from drum, sticks, shakers, tambourines, maracas, xylophones, blocks, and bells. Instrument 100 further includes preset performance settings such as, without limitations, an acoustic drum Kit, a rock drum kit, a hip hop kit, a Latin percussion set, etc., selectable using one or more of the control buttons 150, 160. In the present embodiment, instrument 100 comprises a thumb joystick button 160 and a thumb programmable monetary push button switch 150 on the handle part 120. Joystick button 160 and push button switch 150 enables user of instrument 100 to select additional multiple programmable user performance functions, such as, without limitations, a preset change, a tempo change in addition to triggering additional individual sounds or percussion sound file loops. The multiple programmable user performance functions may be selected using either joystick button 160 or push button switch 150. Further, push button switch 150 may be a force-sensing resistor that changes its resistive value (in ohms Ω) depending on how much it is pressed, providing an additional sound variation functionality.

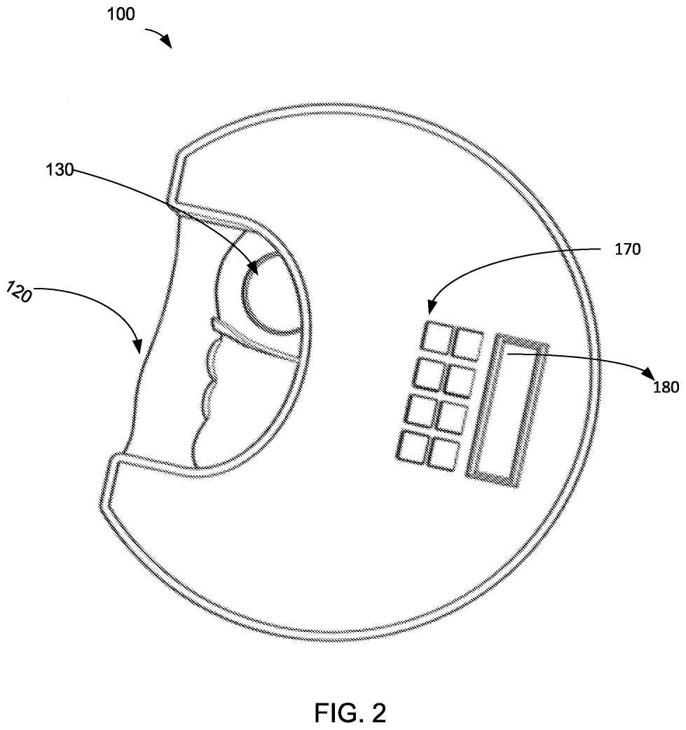

FIG. 2 illustrates a back perspective view of a handheld electronic musical instrument, in accordance with an embodiment of the present invention. In FIG. 2 an arrangement of piezoelectric sensor, control buttons and a display panel on a backplate of instrument 100 is shown. A piezoelectric sensor pad 130 is connected to the handlebar 120. The piezoelectric sensor pad 130 may be triggered by the index finger of the hand used by the user to hold instrument 100 triggering for example, without limitation, a kick drum or other sound file. Further, the backplate of the body part 110 comprises programmable controller buttons 170 and a display screen 180. The display screen includes such as, without limitation, a liquid crystal display (LCD), light emitting diode (LED) display, etc. Programmable controller buttons 170 provides user with the main overview and control of the sound modules parameters and sound library options and general settings associated with electronic percussion instruments. Display screen 180 displays information related to programs selected by controller buttons 170. In one example, without limitations, user holds handle part 120 with one hand and strikes piezoelectric sensor pad 130 placed on the back side of the instrument body 110 with an index finger of the same hand. This action provides, for example, without limitations, the user to trigger a Kick Drum sound file, i.e., when one hand triggers snare drum sound files the other hand's thumb triggers a looped HI Hat sequence sound file. For example, without limitations, the user of instrument 100 may assign any sensor pad 130 or any control button to generate any assignable MIDI command upon receiving a trigger. This may be created by the user during a preset.

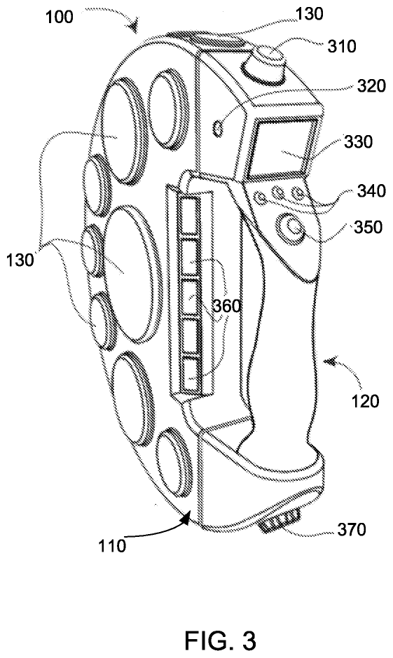

FIG. 3 illustrates a perspective view of a layout of control buttons on a handheld electronic musical instrument, in accordance with an embodiment of the present invention. In FIG. 3 an arrangement of sensor pads 130 and a set of controls 310, 320, 340, 370 is shown. FIG. 3 also illustrates a locking hatch or locking mechanism 360 for locking/engaging the body 110 with handle 120. Sensor pads 130 are arranged on one or more sides of body part 110. For example, without limitations, sensor pads 130 may be arranged on the front side and along a periphery of body part 110. Control buttons or knobs 310, 320, 340, 370 are arranged along handle part 120. Sensor pads 130 perform function as described earlier with reference to FIGS. 1 and 2. The control buttons or knobs arranged along handle 120 include a volume control button 310, a power on/off indicator 320, for example, an LED indicator, momentary push buttons 340, a joystick button 350, and a preset rotary switch 370. Volume control button 310 may be used for controlling the volume of the sound output from instrument 100, power on/off indicator 320 may indicate whether instrument 100 is ON or OFF. Momentary push buttons 340 and joystick button 350 may be operable by thumb and enables user of instrument 100 to select additional multiple programmable user performance functions, such as, without limitations, drum pad sound assignments, drum kit style preset selection, ambience/reverb selection, drum machine features such as, without limitation, a preset change, a tempo change in addition to triggering additional individual sounds or percussion sound file loops. The multiple programmable user performance functions may be selected using either momentary push buttons 340 or joystick button 350. Further, momentary push buttons 340 may be a force-sensing resistor that changes its resistive value (in ohms Ω) depending on how much it is pressed, providing an additional sound variation functionality. Multiple function buttons or programmable controller buttons 170 shown in FIG. 2 provides user with the main overview and control of the sound modules parameters and sound library options and general settings associated with electronic percussion instruments and preset rotary switch 370 enable user may be used to select any preset program. Further, handle 120 includes a display screen 330 for displaying information related to programs selected by one of momentary push buttons 340, preset rotary switch 370, joystick button 350, or Multiple function buttons or programmable controller buttons 170 shown in FIG. 2.

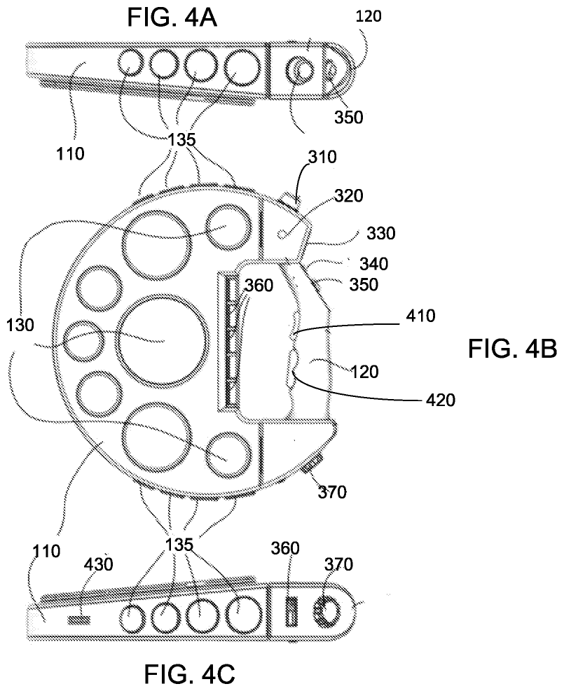

FIGS. 4A, 4B, and 4C illustrate a top, front, and bottom perspective views, respectively, of a layout of sensor pads and control buttons on a handheld electronic musical instrument, in accordance with an embodiment of the present invention. In FIG. 4A, sensor pads 135 such as, without limitations, piezoelectric sensor pads, placed along the periphery of body 110, volume control button 310 and joystick button 350 along handle 120 is shown. For example, without limitations, sensor pads 130 may be triggered for individual sound files, while the sensor pads 135 may be triggered for looped sequences or non-looped sequences like drum fills etc.

In FIG. 4B sensor pads 130 placed on the front side of body part 120 and control buttons/knobs/indicators 310, 320, 340, 350, 370, along handle 120, explained in detail above with reference to FIG. 3 is shown. The handle part 120 further includes finger velocity sensor buttons 410, 420. Finger velocity sensor buttons 410, 420 enable the user of instrument 100 to control variations with respect to MIDI functions. For example, without limitations, velocity sensor buttons 410, 420 may enable the user to control the variation of a Closed and Open Hi Hat with everything in between while playing ae Hi Hat sequence. In FIG. 4C sensor pads 135 such as, without limitations, piezoelectric sensor pads, and USB In/Out connector port 430 placed along the periphery of body 110 is shown. USB In/Out connector port 430 may include any type of USB I/O port such as, without limitations a Type A, a Type B, a mini-USB, or a micro-USB port. Further, FIG. 4C illustrates rotary switch 370 and locking hatch 360.

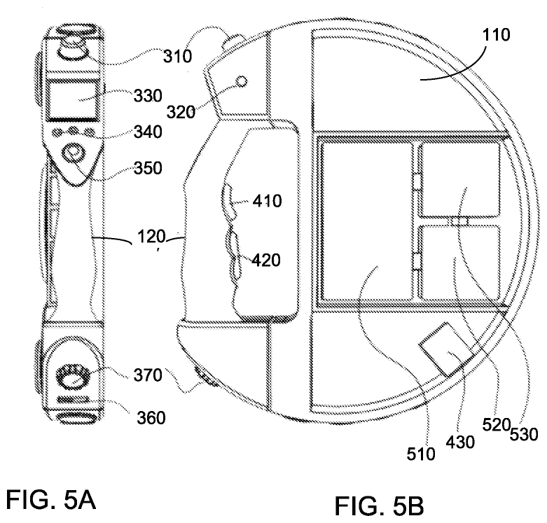

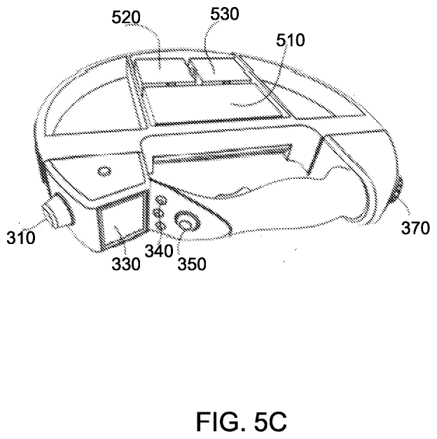

FIG. 5A illustrates an elevation view of a handle of a handheld electronic musical instrument, in accordance with an embodiment of the present invention. In FIG. 5A a volume control button 310, a display screen 330, momentary push buttons 340, a joystick button 350, a locking hatch 360, and a preset rotary switch 370 are shown.

FIG. 5B illustrates a back elevation view of a handheld electronic musical instrument, in accordance with an embodiment of the present invention. In FIG. 5B, the backplate of instrument 100 including a Midi sequence loop & drum fill selector/storage module 510, Midi Bluetooth Transmitter & Receiver 520, a Digital to Analog Audio Wi-Fi & Bluetooth Transmitter 530, and a USB In/Out connector 430 are shown. Midi Sequence Loop & Drum Fill Storage Module 510 includes a set of preprogrammed MIDI sequences, for example, without limitations, hi hat, shakers, ride cymbals, cowbell, etc. MIDI Bluetooth transmitter & receiver 520 transmits MIDI information, such as, without limitations, individual MIDI notes, MIDI Clock Tempo, and MIDI Sequences directly to an external drum machine (not shown) or a computer (not shown), Digital to Analog Audio Wi-Fi & Bluetooth transmitter 530 transmits the audio performance from instrument 100 to public address system such as, without limitations, loudspeaker. USB In/Out connector 430 may connect to any storage device for loading or saving data from instrument 100 to for example, without limitations, a computer.

FIG. 5C illustrates a perspective view of a handheld electronic musical instrument, in accordance with an embodiment of the present invention. In FIG. 5C backplate of body 110 and handle 120 are shown.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing various operating modes of the handheld electronic percussion instrument according to the present invention will be apparent to those skilled in the art. Various aspects of the invention have been described above by way of illustration, and the specific embodiments disclosed are not intended to limit the invention to the particular forms disclosed. The particular implementation of the various operating modes of the handheld electronic percussion instrument may vary depending upon the particular context or application. By way of example, and not limitation, the various operating modes of the handheld electronic percussion instrument. described in the foregoing were principally directed to control buttons, knobs, indicator enabling to perform different operation in the handheld electronic percussion instrument implementations; however, similar techniques may instead be applied to any handheld musical device, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A handheld musical instrument, said handheld musical instrument comprising:
a body portion with one or more sensors; and
a handle portion coupled to said body part, wherein said handle part includes one or more operational buttons to control the operation of said handheld musical instrument.

2. The handheld musical instrument of claim 1, wherein said one or more sensors are piezoelectric sensors.

3. The handheld musical instrument of claim 1, wherein said buttons may be operated with a finger or thumb trigger.

4. The handheld musical instrument of claim 1, wherein said handle portion comprises at least one of:
a joystick button;
a momentary push button;
multiple function buttons; and
a rotary switch, to select a type of program to be played by said handheld musical instrument.

5. The handheld musical instrument of claim 4, wherein said handle portion includes a display for displaying said selected program.

6. The handheld musical instrument of claim 4, wherein said momentary push button detects an associated level of press and varies a sound level based on the detection.

7. The handheld musical instrument of claim 4, wherein selecting a type of program comprises selecting at least one of a drum and percussion style program, a Musical Instrument Digital Interface (MIDI) percussion or musical sequences.

8. The handheld musical instrument of claim 7, further comprising enabling a preset change or a tempo change by operating at least one of said joystick button or said momentary push button

9. The handheld musical instrument of claim 1, wherein said handle portion comprises an on/off light indicator.

10. The handheld musical instrument of claim 1, wherein said handle portion comprises a volume control button.

11. The handheld musical instrument of claim 1, wherein said handle portion comprises a pressure sensitive sensor for generating MIDI patterns.

12. A method comprising steps of:
arranging one or more sensors on a body portion of a handheld musical instrument;
arranging one or more control buttons on a handle portion of said handheld musical instrument; and
performing one or more operations associated with said handheld musical instrument with said one or more control buttons.

13. The method of claim 12, wherein said step of performing one or more operations associated with said handheld musical instrument further comprises a step of selecting a type of program to be played by said handheld musical instrument.

14. The method of claim 13, wherein the step of selecting a type of program further comprises a step of selecting at least one of a drum and percussion style program, a Musical Instrument Digital Interface (MIDI) percussion or musical sequences.

15. The method of claim 12, wherein said step of arranging one or more control buttons on a handle portion of said handheld musical instrument further comprises the step of arranging said control buttons on one side of said handle portion.

16. The method of claim 15, wherein said step of arranging said control buttons on one side of said handle portion comprises placing a joystick button or a momentary push button on said one side of said handle portion.

17. A method for operating a handheld musical instrument, the method comprising the steps of:
placing one or more finger velocity sensors on a handle portion of a handheld musical instrument; and
triggering one or more audio sequences with said one or more finger velocity sensors.

18. The method of claim 17, wherein said audio sequences comprises MIDI functions.

19. The method of claim 1817, further comprising said finger velocity sensors controlling variations associated with said MIDI functions.

20. The method of claim 19, further comprising controlling the variation of a closed and open Hi Hat sequence.
